(19) United States
(12) Patent Application Publication
(10) Pub. No.: US 2019/0375145 A1
(43) Pub. Date: Dec. 12, 2019

(54) ENTRAINMENT DEVICE

(71) Applicant: Weiler Engineering, Inc., Elgin, IL (US)

(72) Inventors: Paul Novorolsky, DeKalb, IL (US); Mark Stevenson, Lombard, IL (US)

(21) Appl. No.: 16/002,380

(22) Filed: Jun. 7, 2018

(51) Int. Cl. B29C 49/42

(52) U.S. Cl. CPC B29C 49/4252; B29C 49/46

(57) ABSTRACT

Smoke and particulate matter generated as an extruded parison segment is severed by a hot wire, and the like, is gathered by an entrainment device mounted to the head portion of an extruder. The entrainment device is a hollow housing in which a gas jet generates a region of pressure less than ambient pressure at the extruder head. As a result, smoke and particulate matter at the extruder head portion are drawn into the hollow housing and are exhausted to a location away from the extruder head portion.

### FIELD OF INVENTION

This invention relates to an apparatus for molding a container. More particularly, this invention relates to a device for containment of smoke and particulates generated during a blow molding process

### BACKGROUND OF INVENTION

An apparatus and method for blow molding and filling hollow thermoplastic containers are described, inter alia, in U.S. Pat. No. 4,707,966 to Weiler et al. A thermoplastic parison in the form of a hollow tube is extruded continuously through an extruder head and between a pair of coacting main mold halves. The molding method includes a step of cutting off a segment of the parison below the extruder head and above the main mold halves so as to create an opening in the parison segment which permits a blowing and filling nozzle assembly to be positioned into the opening for molding and thereafter filling and sealing a molded container.

Cutting of the parison segment usually involves the use of a hot moving cutter, such as a hot wire or hot blade, which melts through and severs the parison. Smoke and suspended particulate matter are generated during the cutting process. A potential disadvantage associated with such practice is the risk that smoke and particulate matter may be introduced into the molded container and dispersed into the surroundings.

The present invention provides an effective device for containment of smoke and particulates generated as a parison segment is severed from an extruded parison.

### SUMMARY OF INVENTION

Containment of particulates and vapors generated when an extruded parison segment is severed during operation of a blow/fill/seal packaging machine is achieved by a gas-driven entrainment device that surrounds an extruded parison.

Entrainment of smoke and particulates generated in the vicinity of an extruded parison, in particular when a parison segment is severed by a hot wire or knife blade, is achieved by providing a solid convex surface around an extruded parison which surface defines an entrainment port, a main gas flow path, and also provides an exhaust port. A pressurized gas stream is introduced along the convex surface, in a direction from the entrainment port toward the exhaust port at a gas flow rate sufficient to generate a Coanda effect, i.e., adhesion of a gas jet to a solid surface, in the main flow path and to draw ambient air, along with smoke and particulates into the entrainment port. Gas flow in the main flow path carries entrained smoke and particulates away from the parison and through the exhaust port.

A particle entrainment device suitable for use on a blow/fill/seal packaging machine includes a hollow housing that defines an annular plenum chamber having an entrainment port and associated with a peripheral aspirating nozzle that induces entraining gas flow into the plenum chamber. The main flow path through the device is defined by the annular plenum chamber. An exhaust port is provided in communication with the plenum chamber for smoke and particulate removal.

In particular, the entrainment device is provided with a hollow housing that has an upper portion, an open lower portion, a tubular outer wall that depends from the upper portion of the housing and extends into the lower portion, and a tubular inner wall which is spaced from the outer wall, depends from the upper portion of the housing and extends into the lower portion of the housing. The interior face of the outer wall has a convex configuration. The distal end portion of the outer wall is provided with a peripheral channel or groove. A bottom plate covers the distal end portion over the groove and, together with the distal end portion, defines a peripheral induction flow passageway and a peripheral aspirating nozzle in fluid flow communication with the induction flow passageway as well as with an annular plenum chamber which is defined in the housing between the outer wall and the inner wall. The bottom plate can be a separate piece bonded to the housing or fabricated unitary with the housing, as desired.

The inner wall also defines a through aperture in the housing for accommodating the head of a parison extruder.

The housing is provided with at least one induction gas inlet port, but preferably a pair of opposed induction gas inlet ports, for the induction flow passageway and with at least one exhaust port in the upper portion of the housing in fluid flow communication with the annular plenum chamber for smoke and particulate removal.

Entraining inducing gas is introduced into the annular plenum chamber under pressure, and can be air or an inert gas such as nitrogen.

The induction nozzle has an induction flow outlet spaced from the entrainment port and in fluid flow communication with the annular plenum chamber.

Preferably the entrainment device is provided with a pair of opposed exhaust ports and a pair of induction gas inlet ports.

### BRIEF DESCRIPTION OF DRAWINGS

In the drawings,

FIG. 1 is a perspective view of an entrainment device embodying the invention and mounted to the head of an extruder;

FIG. 2 is a bottom view of an entrainment device embodying the invention;

FIG. 3 is a sectional view along plane 3-3 in FIG. 2;

FIG. 4 is an enlarged view of a circled portion of FIG. 3;

FIG. 5 is a plan view of the bottom plate of the entrainment device of FIG. 2;

FIG. 6 is a sectional view along plane 6-6 in FIG. 5;

FIG. 7 is a perspective view of the entrainment device housing of FIG. 2;

FIG. 8 is a side elevation of the entrainment device housing shown in FIG. 7; and

FIG. 9 is a sectional view taken along plane 9-9 in FIG. 8.

### DESCRIPTION OF PREFERRED EMBODIMENTS

For ease of description, the entrainment device embodying this invention will be described in its normal (upright) operating position, and terms such as upper, lower, horizontal, etc. will be used with reference to its normal operating position. The device embodying the invention, however, may be fabricated, stored, transported, and sold in an orientation other than the position described herein.

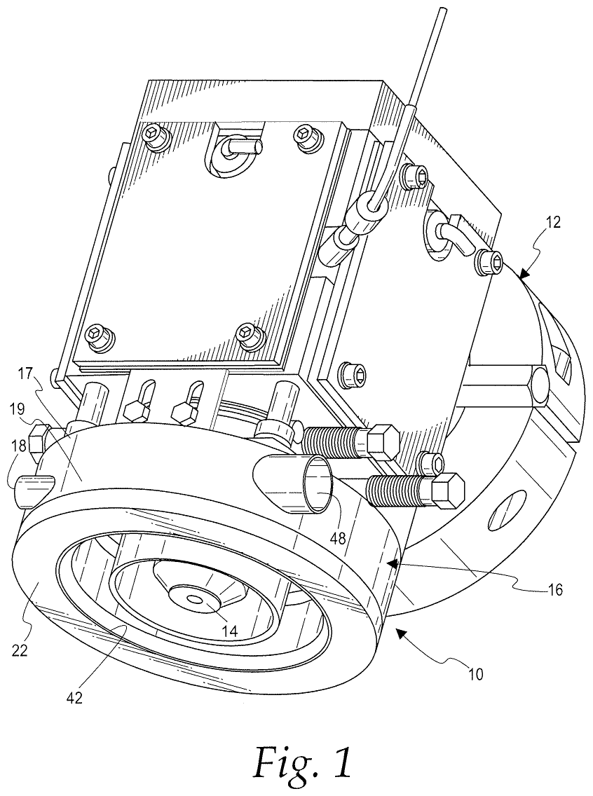

Referring to the drawings, FIG. 1 shows entrainment device 10 mounted to extruder 12 so as to surround extruder head 14 from which a parison is extruded when in operation. Device 10 includes housing 16, having upper portion 17 and lower portion 19, together with bottom plate 22 mounted thereto, and is provided with induction gas inlet port 18 and exhaust port 48.

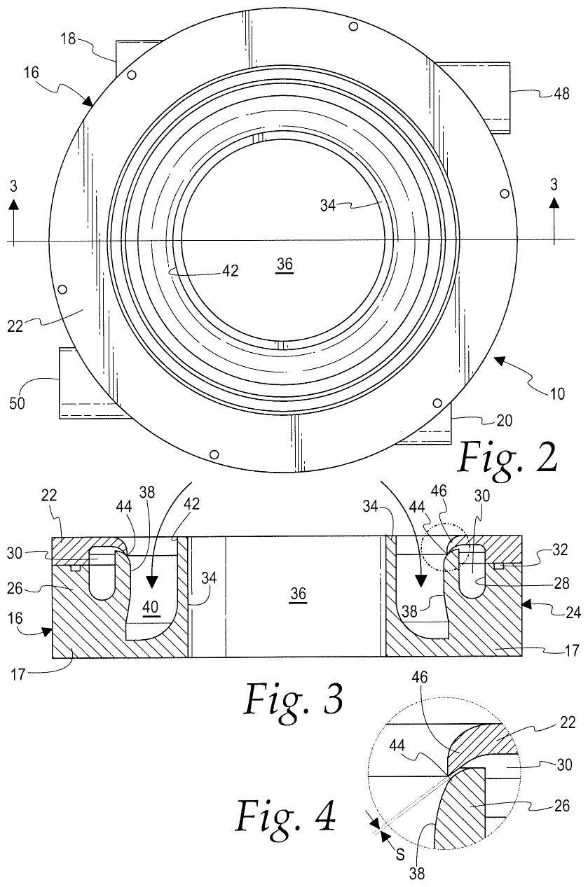

FIG. 2 shows the underside of entrainment device 10, and FIG. 3 is a sectional view taken along plane 3-3 in FIG. 2. Bottom plate 22 is situated over distal end portion 26 of tubular outer wall 24 which, in turn, depends from upper portion 17 of housing 16. Tubular inner wall 34 likewise depends from upper portion 17 of housing 16 and is spaced from outer wall 24. Inner wall 34 together with upper portion 17 of housing 16 define through aperture 36 in the housing.

Distal end portion 26 of outer wall 24 defines peripheral channel 28 (FIG. 3) which, together with bottom plate 22, defines induction flow passageway 30 in fluid flow communication with induction gas inlet ports 18 and 20. Interior face 38 of outer wall 24 has a convex shape, preferably defining a Coanda profile.

Tubular outer wall 24, tubular inner wall 34, circular bottom plate 22 and upper portion 17 of housing 16 together define annular plenum chamber 40 having entrainment port 42.

Inner periphery 46 of circular bottom plate 22 is spaced from convex interior face 38 of outer wall 24 and defines peripheral aspirating nozzle 44 therebetween. Preferably the inner periphery of bottom plate 22 has a cheliform or claw-shaped cross-section as shown in FIGS. 3 and 4.

The spacing S between inner periphery 46 and convex interior face 38 usually is about 0.006 to about 0.01 inch (about 0.15 mm to about 0.25 mm), preferably about 0.008 inch (about 0.2 mm). In operation, the rate of gas flow through the nozzle is at least 20 meters/second, and preferably is in the range of about 30 m/sec to about 60 m/sec.

Peripheral aspirating nozzle 44 is in fluid flow communication with induction flow passageway 30 as well as with annular plenum chamber 40. Aspirating nozzle 44 directs a gas jet along convex interior face 38, preferably tangential to interior face 38, thereby creating a region of less than ambient pressure in plenum chamber 40, generating a Coanda effect within the plenum chamber, and drawing ambient air into plenum chamber 40. As a result, smoke and particulate matter around the extruder head are drawn into annular plenum chamber 40 through annular entrainment port 42 (FIGS. 1-3). Induced air flow into plenum chamber 40 is indicated by a pair of arrows in FIG. 3.

Exhaust ports 48 and 50 likewise are in fluid flow communication with plenum chamber 40 and serve to provide convenient means for removal of smoke and particulates gathered within plenum chamber 40. If desired, an exhaust fan (not shown) can be provided downstream from exhaust ports 48 and 50 to facilitate removal from plenum chamber 40.

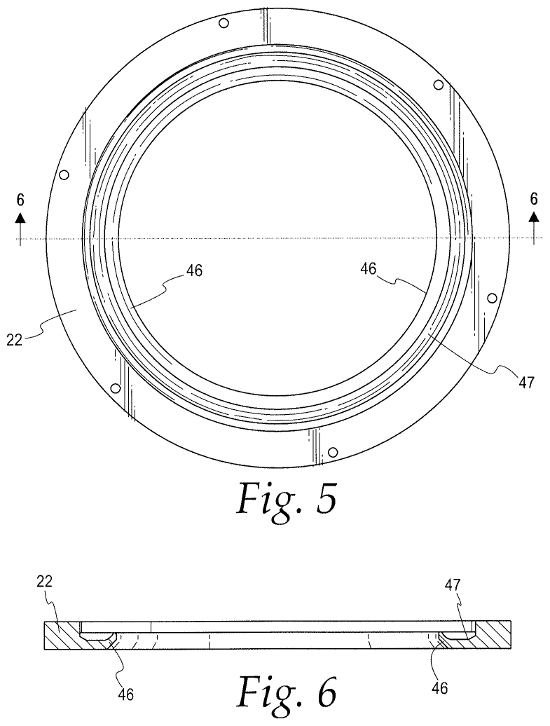

FIGS. 5 and 6 show configuration of circular bottom plate 22 which defines peripheral trough 47 and inner periphery 46 having a cheliform cross-section. Trough 47 in bottom plate 22 together with peripheral channel 28 in outer wall 24 define induction flow passageway 30 which supplies gas to peripheral aspirating nozzle 44 (FIG. 3).

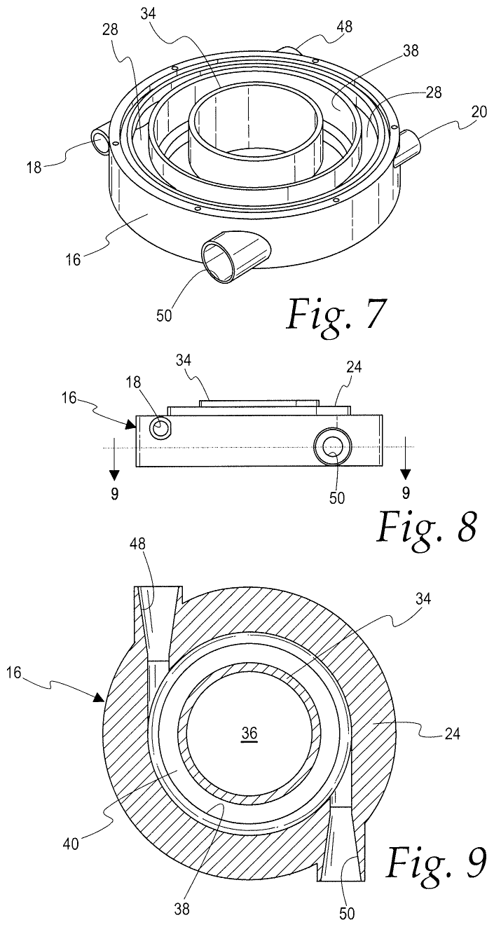

FIGS. 7, 8 and 9 further illustrate interior detail of hollow housing 16. Peripheral channel 28 in outer wall 24 receives gas flow via induction gas inlet ports 18 and 20, and dispenses pressurized induction gas into annular plenum chamber 40 via peripheral aspirating nozzle 44 (FIGS. 3 and 4). The induction gas flow into plenum chamber 40 creates a negative pressure region therein and as a result aspirates by entrainment any smoke and particulate matter in the vicinity of annular entrainment port 42 (FIGS. 1-3). Smoke and particulate matter are removed from annular plenum chamber 40 through exhaust ports 48 and 50.

The foregoing description and the drawings are intended as illustrative and are not to be taken as limiting. Variations, modifications, and rearrangements of parts are possible without departing from the spirit and scope of the described embodiments and will readily present themselves to those skilled in the art.

1. Entrainment device for a blow/fill/seal packaging machine which comprises
a hollow housing having an upper portion, an open lower portion, a tubular outer wall depending from the upper portion and extending into the lower portion, and a tubular inner wall spaced from the outer wall, depending from the upper portion and extending into the lower portion, and a circular bottom plate mounted to a distal end portion of the outer wall, the outer wall defining a convex interior face and the upper portion together with the tubular inner wall defining a through aperture in the housing;
the tubular outer wall, the tubular inner wall, and the circular bottom plate together with the upper portion of the housing defining an annular plenum chamber with an annular entrainment port at the lower portion of the housing;
the outer wall having a peripheral groove at the distal end portion thereof and together with the bottom plate defining a peripheral induction flow passageway and a peripheral aspirating nozzle in fluid flow communication with the induction flow passageway and with the annular plenum chamber;
at least one induction gas inlet port defined in the outer wall and in fluid flow communication with the induction flow passageway; and
at least one exhaust port defined in the upper portion of the housing and in fluid flow communication with the annular plenum chamber.

2. The entrainment device of claim 1 having a pair of opposed exhaust ports and a pair of opposed induction gas inlet ports.

3. The entrainment device in accordance with claim 1 wherein the outer wall defines a circular passageway between the induction outlet and the induction air inlet port.

4. The entrainment device in accordance with claim 1 wherein the nozzle is configured to guide induction air flow tangentially along the convex inner face of the outer wall.

5. The entrainment device in accordance with claim 4 wherein the convex inner face defines a Coanda profile.

6. The entrainment device in accordance with claim 1 wherein the induction nozzle is a convergent nozzle defined by opposed curved surfaces spaced from one another but converging to define a peripheral gap at the inner face of the outer wall.

7. The entrainment device in accordance with claim 6 wherein the peripheral gap is in the range of about 0.006 to about 0.01 inch.

8. A method for containment of smoke and particulates generated in vicinity of an extruded parison during a blow molding process comprises
providing a solid convex surface around an extruded parison, the convex surface defining an entrainment port, communicating with an exhaust port, and defining a main gas flow path therebetween; and
introducing a pressurized gas stream along the convex surface in a direction from the entrainment port toward the exhaust port at a gas flow rate generating a Coanda effect in the main flow path and drawing ambient air into the entrainment port.

9. The method in accordance with claim 8 wherein the gas flow rate is at least 20 meters per second.

10. The method in accordance with claim 8 wherein the gas flow rate is in the range of about 30 meters per second to about 60 meters per second.
